(19) United States
(12) Patent Application Publication
(10) Pub. No.: US 2010/0301037 A1
(43) Pub. Date: Dec. 2, 2010

(54) FOOD TREATING DEVICE

(76) Inventor: Ernst Wüst, Staad (CH)

Correspondence Address: MOETTELI & ASSOCIATES SARL, ST. LEONHARDSTRASSE 4, ST. GALLEN, CH-9000, CH

(21) Appl. No.: 12/065,515

(22) PCT Filed: Mar. 3, 2005
(86) PCT No.: PCT/CH2005/000124

§ 371 Date: Jul. 26, 2010

(30) Foreign Application Priority Data
Mar. 3, 2004 (CH) 352/04

(51) Int. Cl. H05B 6/12

(52) U.S. Cl. 219/620

(57) ABSTRACT

The inventive device comprises a body (1) provided with side walls (3, 4) and superimposed planar horizontally extending induction units (10) between which containers for food to be prepared (20) can be introduced. The induction units (10) are associated by one part (29) of the edge thereof with the respective side wall (3, 4) in such a way that said induction units (10) form the bottom of open compartments (19). Said device also comprises a carriage (30) having a practically vertically extending body (31). Holders (35) for the containers (20) are protruded from the sides of the base body (31) of the carrier. Each container (20) is disposed between two superimposed induction units.

The present invention relates to an apparatus for treating food.

Apparatuses of this generic type are already known. Treating can be understood as the so-called regeneration of food, which just means defrosting and heating food to a desired temperature. However, treating may also be understood to mean, for example, keeping food or the like warm. Apparatuses of this generic type are used in airplanes and on ships, trains, coaches, etc. Known apparatuses of this generic type comprise a housing in which at least one heating element, a washer source and a fan are located. The food which is to be regenerated is located in containers which are normally made of aluminum and have a bowl-like bottom part and a lid, the lid normally being fixed to the bottom part. The food is supplied for regeneration in the cooled or frozen state. The lid contains openings.

Water from the water source is evaporated with the aid of the heating element. The fan is used to circulate the air/steam mixture through the apparatus housing and around the food containers. In this case, the air/steam mixture also penetrates into the interior of the food containers, which accelerates the regeneration of the food located in the containers. Since the steam comes into contact with cold food containers, it is cooled to the extent where it condenses to form water. This water poses problems not just inside the apparatus, but also in the area surrounding the same.

The object of the present invention is to eliminate the abovementioned, and additional, disadvantages of the prior art.

This object is achieved according to the invention, in the case of the apparatus of the generic type mentioned in the introduction, as defined in the characterizing part of patent claim 1.

Embodiments of the present invention are explained in more detail hereinbelow with reference to the accompanying drawings, in which:

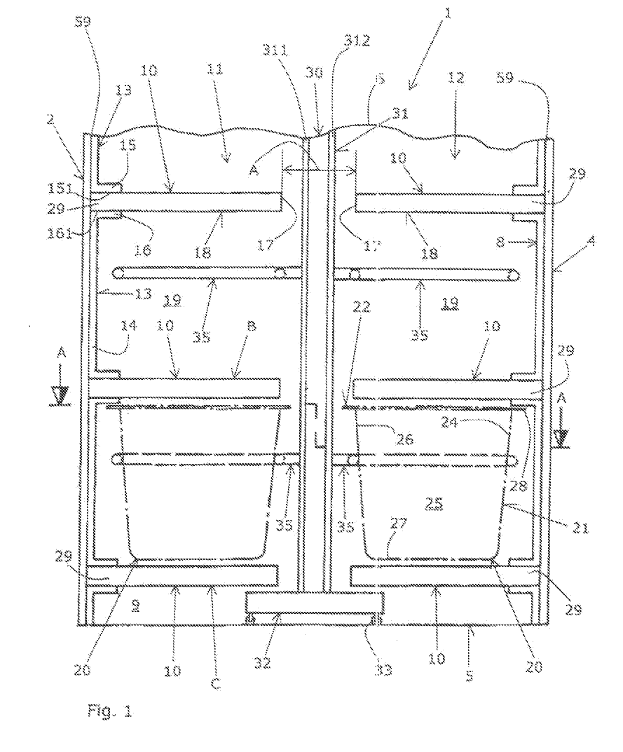

FIG. 1 shows a front view of the bottom section of a first embodiment of the present apparatus which has a number of inductors,

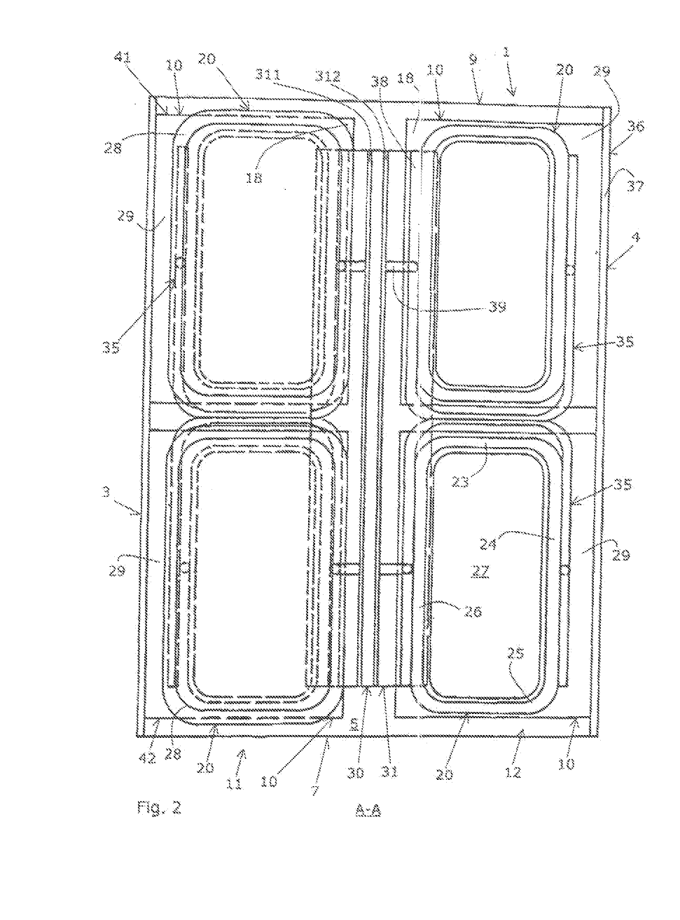

FIG. 2 shows a section A-A through the apparatus according to FIG. 1,

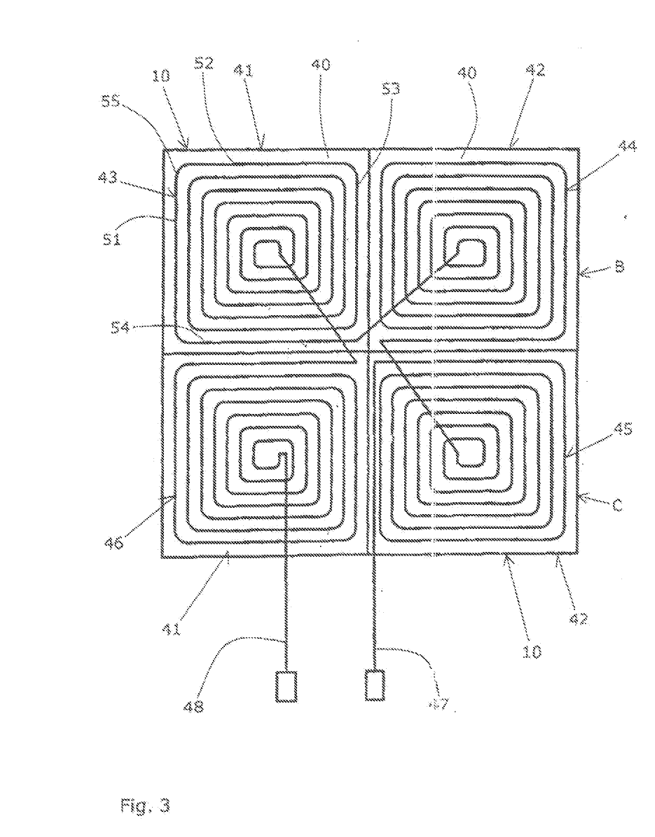

FIG. 3 shows the inductors of the apparatus according to FIG. 1 in an interconnected state,

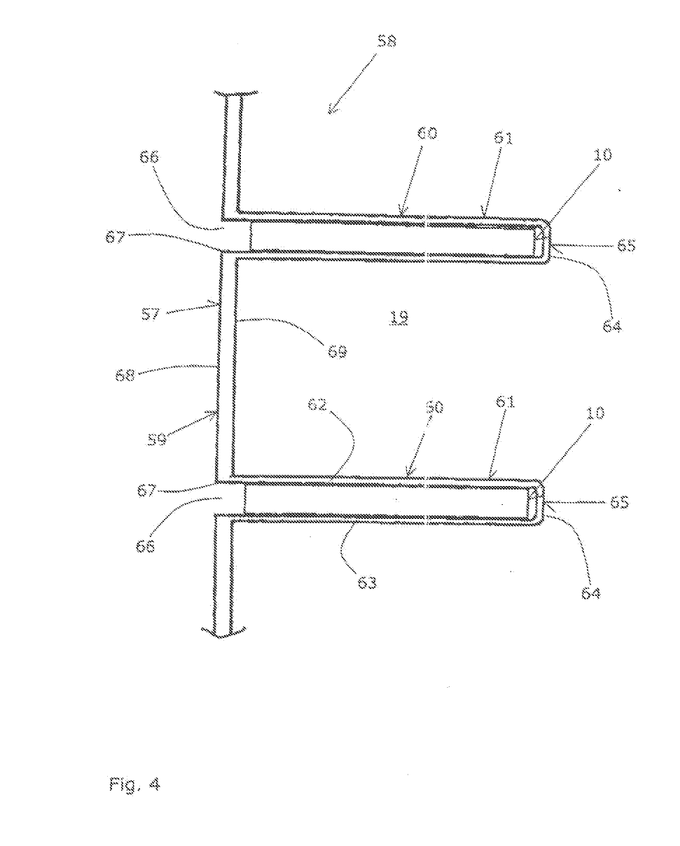

FIG. 4 shows in a vertical section, and on an enlarged scale, a detail of a second embodiment of the present apparatus,

FIG. 5 shows, in perspective, a further embodiment of the present apparatus,

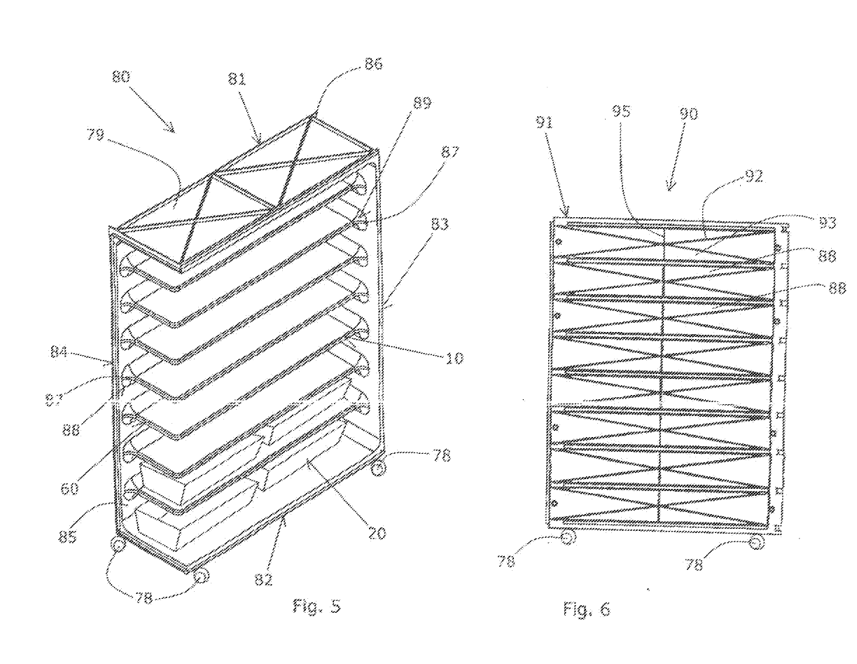

FIG. 6 shows a side view of yet a further embodiment of the present apparatus,

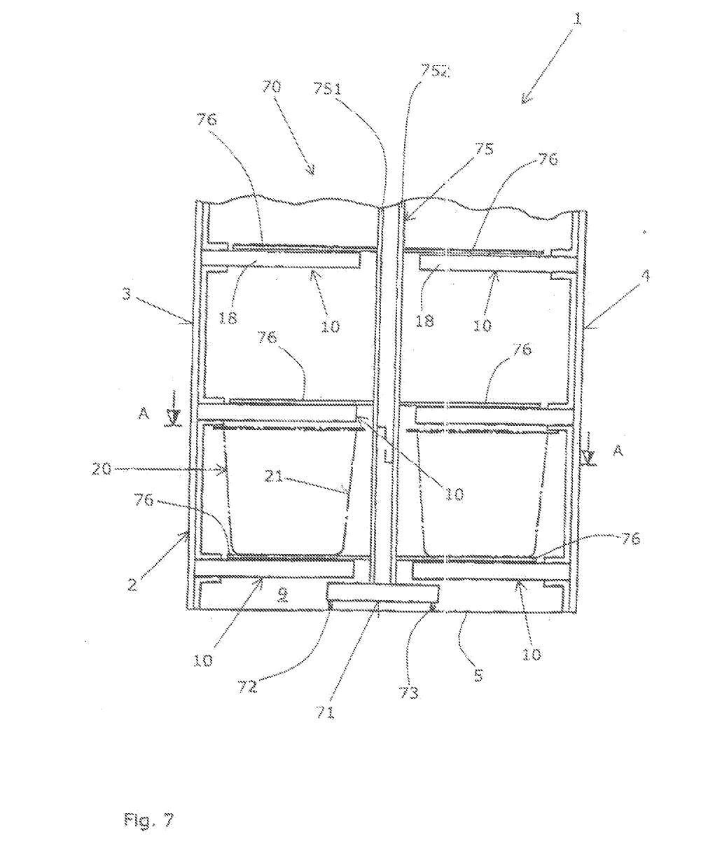

FIG. 7 shows a front view of the bottom section of yet a further embodiment of the present apparatus, having a number of inductors,

FIG. 8 shows a side view of a further embodiment of the present apparatus, it being possible for this embodiment to serve as a tunnel oven,

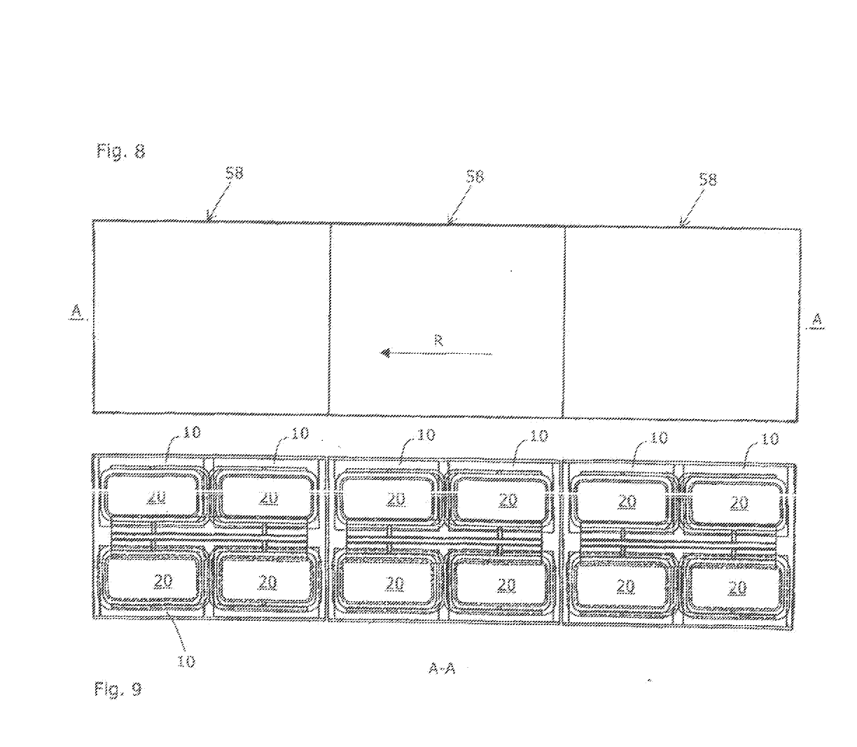

FIG. 9 shows a horizontal section A-A through the apparatus according to FIG. 8,

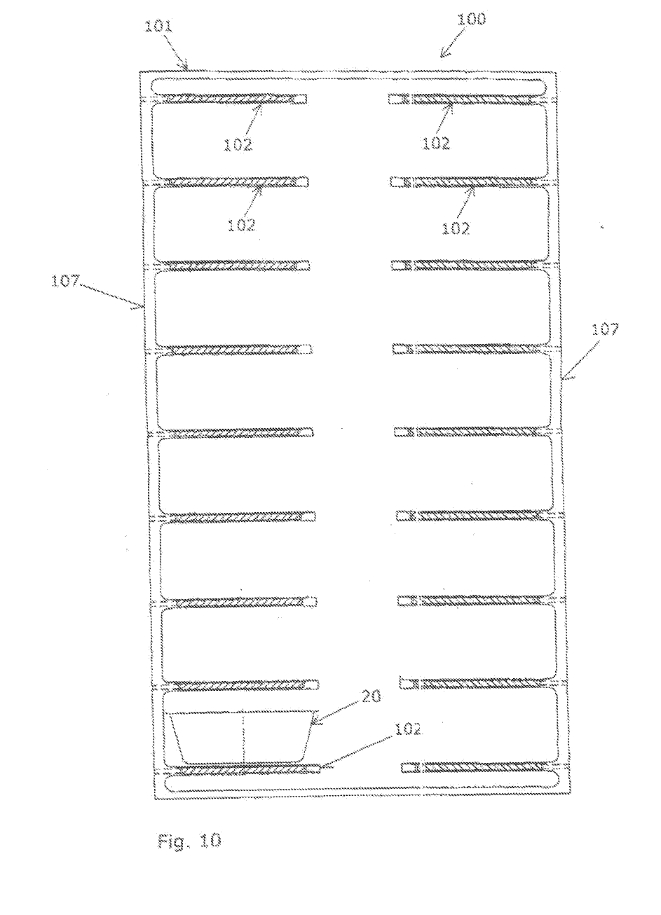

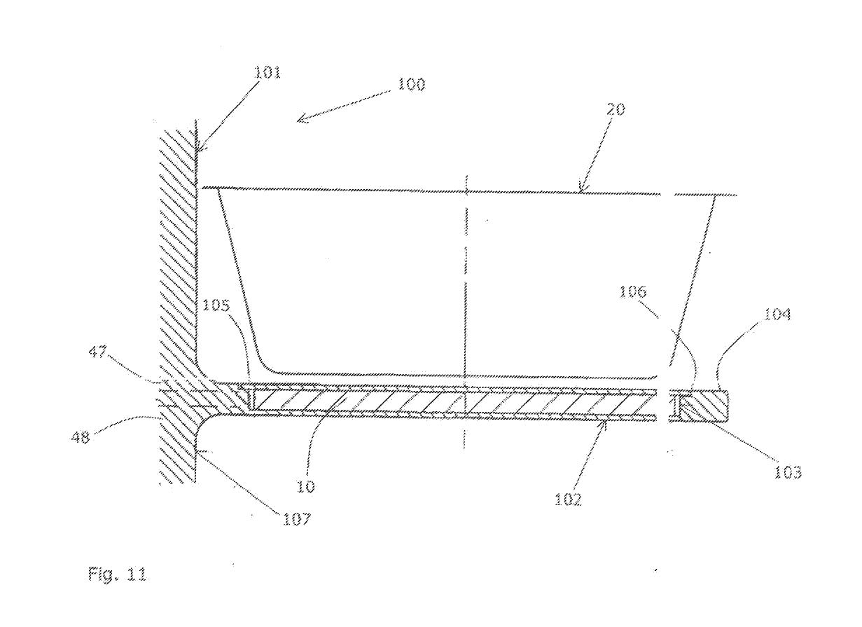

FIG. 10 shows a vertical section through a further embodiment of the present apparatus,

FIG. 11 shows, on an enlarged scale, a detail from FIG. 10,

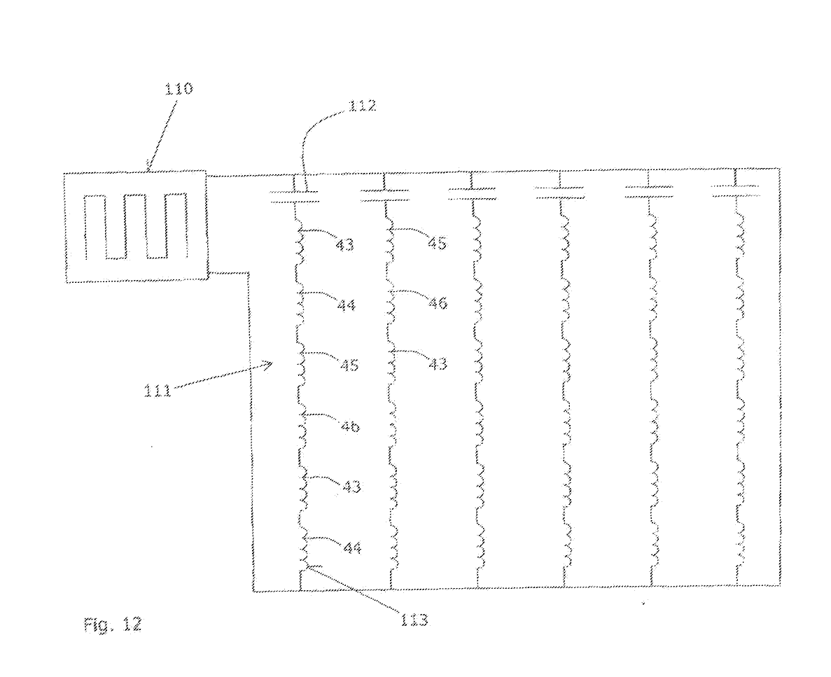

FIG. 12 shows a first embodiment of the supply part for the present apparatus,

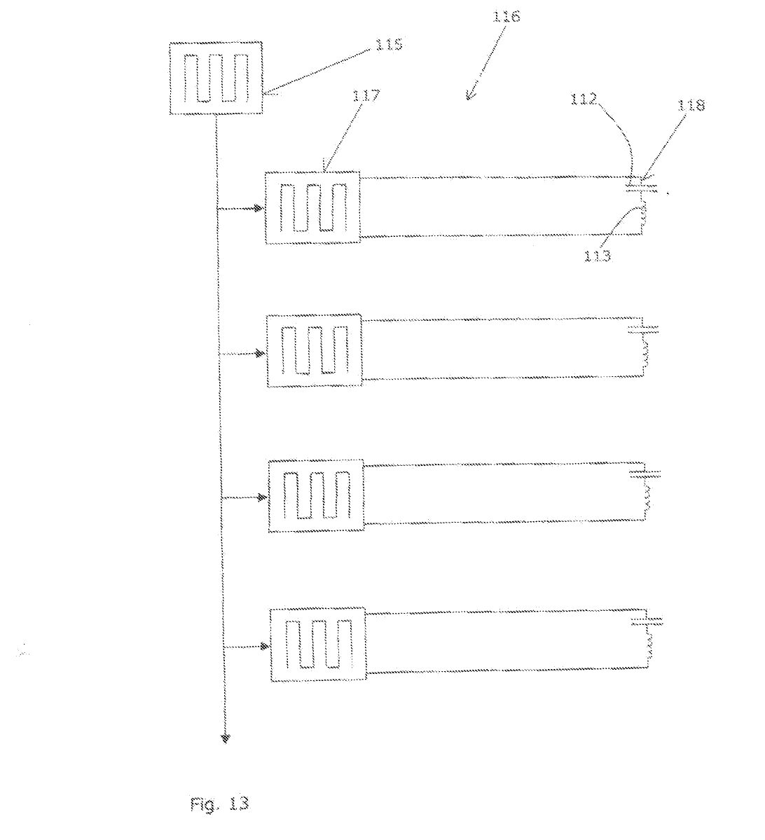

FIG. 13 shows a second embodiment of the supply part for the present apparatus, and

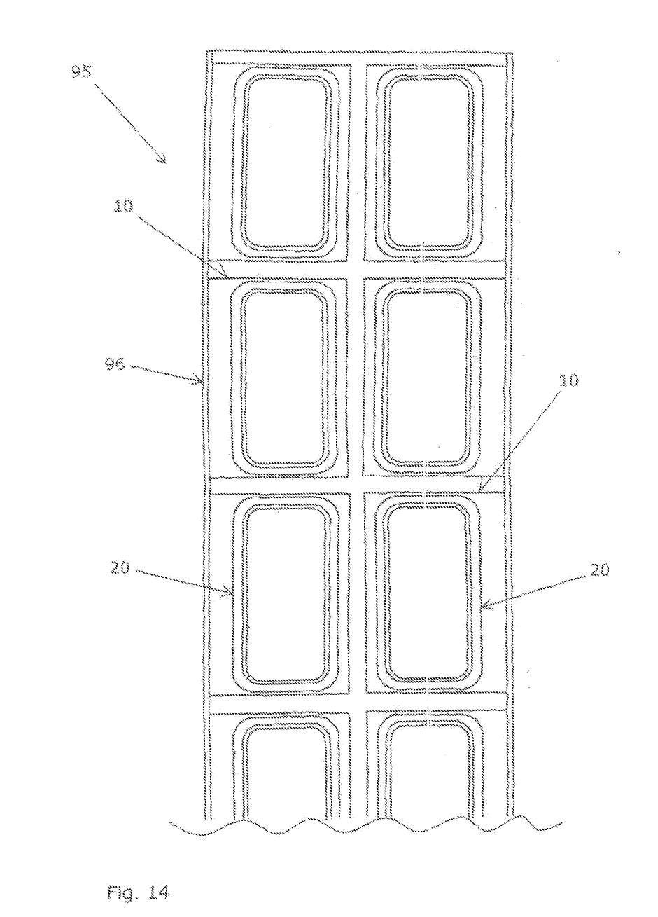

FIG. 14 shows a plan view of a so-called hot plate.

The present apparatus for preparing food comprises an oven 1. In the case which is illustrated in FIGS. 1 and 2, this oven 1 also comprises, inter alia, a frame 2 and a rear wall 6 on the rear side of the frame 2. The frame 2 is made up of two side walls 3 and 4, a base 5 and a top (not illustrated). These constituent parts of the oven 1 are advantageously connected rigidly to one another. It is expedient if the front side 7 of the frame 2 can be closed off with the aid of a door (not illustrated) which is known per se and is assigned, in a manner which is likewise known per se, to the front side 7 of the frame 2. The food which is to be prepared is located in containers 20.

The present apparatus also comprises planar induction units 10 which are assigned to the inside 59 of the side walls 3 and 4 of the apparatus frame 2 and run practically horizontally. These panel-like induction units 10 are arranged one above the other. The distance between two induction units 10 located one above the other is selected such that a container 20 for accommodating the food which is to be prepared may be placed, snugly, between two planar induction units 10 located one above the other.

As can be seen from FIG. 2, the respective induction unit 10 comprises two inductors 41 and 42 located close up against one another in the same plane. These inductors 41 and 42 are of essentially identical design and butt against one another by way of one of their shorter sides in each case. The respective inductor 41 or 42 has a panel-like basic body 40, which is advantageously made of a plastic. The peripheral surfaces of this basic body 40 have an encircling groove (not illustrated) cut into them, the winding of a coil 43, 44, 45 or 46 being located in this groove. The coils of the inductors 41 and 42 in one of the induction units 10 are connected in series and the windings of the series-connected coils 43, 44, 45 and 46 are oriented in opposite directions.

The respective container 20 comprises a hollow bowl-like bottom part 21 and a practically planar lid 22. Both the bowl 21 and the lid 22 are thin-walled and they may be made of a metal in which it is possible to induce eddy currents.

The container 20 is advantageously made of aluminum. In the case illustrated, the bottom part 21 of the container 20 has a rectangular outline, so that it has four side walls 23, 24, 25 and 26 and a base 27. The side walls 23, 24, 25 and 26 extend upward from the base 27 and, in the process, diverge from one another in the upward direction. The top periphery of the bottom part 21 is provided with a flange 28 which projects outward, i.e. laterally and practically horizontally, from the side walls 23, 24, 25 and 26 and has the container lid 22 resting on it and is connected to the container lid 22, if necessary, in an air-tight manner. If desired, the container lid 22 may have openings (not illustrated). The food located in containers 20 is heated in a manner known per se by the eddy currents induced in the thin walls of the container 20.

The size of the distance between two induction units 10 located one above the other is selected so as to provide the smallest possible distance between the lid 22 of the container 20 and an induction unit. In this case, the energy which is necessary for warming or heating food can also be imparted to the container 20 by the induction unit 10 which is located above the container 20, i.e. in the vicinity of the planar container lid 22. The surface area of the respective inductor 41 or 42, which, in the case illustrated, likewise has a rectangular outline, is selected to be at least equal to the surface area of the bowl flange 28 and the outline of the container 20, in order that as much energy as possible can be transmitted from the inductors 41 and 42 to the respective container 20.

In the case illustrated, the horizontally running induction units 10 in the frame 2 form two vertically running rows 11 and 12. The induction units 10 of the respective row 11 or 12 have their longer peripheral parts 29 assigned to the inside 59 of the relevant frame side wall 3 or 4, respectively, the main plane of the induction units 10 running practically horizontally. The induction units 10 of the vertical rows 11 and 12, these induction units being located one above the other, thus jut out, i.e. project from the inside 59 of the respective frame wall 3 or 4. The mutually opposite longer peripheral parts 18 of the rectangular induction units 10 are thus located freely in the central region of the frame 2 and/or of the housing 1 of the present apparatus.

Holders 8 are provided in order to secure the respective induction unit 10 in place. The respective holder 8 has a basic body 13 which, in the case illustrated, is configured as a U-profile 13. This U-profile 13 has a central section 14 and legs 15 and 16 which project perpendicularly from the central part 14. The holder 8 is fastened on the inside of the frame side wall 3 or 4 via its central section 14. A plurality of such U-profiles 13 are arranged one above the other, the outer peripheral part 29 of one of the induction units 10 being clamped between the outer surfaces 151 and 161 of the legs 15 and 16 of two adjacent U-profiles 13 (FIG. 1). In this way, the induction units 10 define open compartments 19 in the region of the inner surface 59 of the frame side walls 3 and 4 of the present apparatus. The lowermost induction units 10 in the housing 1 are spaced apart from the floor 5 of the oven 1, this spacing being smaller, in the example illustrated, than the height of a compartment 19. The floor 5, the induction units 10 located thereabove, and the corresponding sections of the side walls 3 and 4 define a floor space 9 in the housing 1.

The oven 1 and the frame 2 are wide enough for the end surfaces 17 of the inner elongate peripheral parts 18 of the induction units 10 to be spaced apart from one another by a distance A. A free space is thus present between these inner elongate peripheral parts 18 of the induction units 10. The distance A between the inner elongate peripheral parts 18 of the induction units 10 may be selected to be of such a magnitude that the basic body 31 of a framework or of a trolley 30 may be placed between these inner peripheral parts 18 of the induction units 10. This trolley 30 is intended for accommodating containers 20 with food which are to be warmed or heated simultaneously. These food trolleys 30 extend practically over the entire depth of the induction units 10 and/or of the oven 1 or frame 2 (FIG. 2).

The trolley 30 comprises an undercarriage 32 with wheels 33 of a type known per se, it being possible for this to be placed in the floor space 9 of the housing 1. The width of the undercarriage 32 is selected to be greater than the distance A between the inner longitudinal peripheries 18 of the induction units 10, in order to achieve sufficient lateral stability of the trolley 30. A flat basic body 31 of the food trolley 30 extends upward approximately from the center of the undercarriage 32. In the example illustrated, this basic body 31 comprises two parallel panels 311 and 312 which are spaced apart vertically from one another by a distance B and extend practically over the entire height of the oven 1. The distance B between the panels 311 and 312 is smaller than the distance A between the mutually opposite induction units 10.

Practically horizontally running holders 35 for the food containers 20 project at least from one of the sides of the basic body 31 of the trolley. The respective holder 35 comprises a retaining section 36 which, in the example illustrated, is U-shaped and of which the main plane runs practically horizontally. The legs 37 and 38 of the U-shaped retaining section 36 run practically parallel to the longitudinal peripheries 18 and 29 of the induction units 10. The first U-leg 37 is located closer to the side wall 3 or 4, and the second U-leg 38 is located closer to the basic body 31 of the food trolley 30.

Approximately in the center of the length of the second U-leg 38, a connecting component 39 adjoins this U-leg 38 at one end. The other end of this connecting component 39 is fastened on the basic body 31 of the food trolley 30.

The U-shaped retaining sections 36 illustrated open in the outward direction, i.e. forward and rearward in respect of the longitudinal direction of the basic body 31 of the trolley. This allows the food containers 20 to be easily loaded onto, and unloaded from, the U-holders 35. The main dimension of the retaining section 36, in the case illustrated this being the distance between the U-legs 37 and 38, corresponds to the average distance between the longer side walls 24 and 26 of the rectangular container 20. This allows the legs 37 and 38 to retain the food containers 20 approximately halfway up their height, as is illustrated in FIG. 1.

The distance between two holders 35 located one above the other is selected such that a holder 35 of the trolley 30 is arranged in in each case one compartment 19 between two induction units 10 of the frame 2. To be more precise, the height of the holder 35 is set such that the base 27 of the container 20 retained by one of the holders 35 is located just above the induction unit 10 located therebeneath, so that the container base 27 does not come into contact with this induction unit 10 and thus does not stand on the same. Of course, the retaining sections 36 may also be configured differently, in particular if the food containers 20 are of a shape other than that described above. The profile of the shape of the retaining sections 36 is to be optimally adapted to the profile of the shape of the side walls of the food containers 20.

Two induction units 10 located one above the other which, on account of the following explanation, are designated B and C (FIGS. 1 and 3) form an induction group. The latter comprises the four inductors 41 and 42 of the two induction units 10 with a total of four windings 43, 44, 45 and 46. The windings 43 to 46 of the inductors 41 and 42 are configured from a litz wire and are connected in series. The electrical connection between the four windings 43, 44, 45 and 46 is illustrated in FIG. 3. B is used in FIG. 3 to designate the left-hand induction unit 10 which is second from the bottom in FIG. 1. C is used in FIG. 3 to designate the left-hand induction unit 10 which is located at the bottom in FIG. 1. However, FIG. 3 illustrates these induction units B and C as being located in the same plane.

Supply leads 47 and 48 constitute continuations of the start and the end of the windings 43 to 46. The respective winding 43 to 46 has rectilinearly running turn sections 51, 52, 53 and 54. These rectilinear turn sections 51 to 54 are arranged such that they run parallel to one of the edges of the quadrilateral basic body 40 of the respective induction unit 10 or B and C. A turn section 55 with pronounced curvature is provided between in each case two rectilinear turn sections 51 to 54, this turn section 55 constituting a curve with a central angle of 90 degrees. By virtue of these curved sections 55, the rectilinear sections 51 to 54 of the respective turn are connected one behind the other, i.e. in series, so that, together with the curved sections 55, they each constitute one of the turns of the windings 43 to 46.

The windings 43 to 46 of the inductors 41 and 42 are arranged and oriented such that the rectilinear sections 51 to 54 of the turns of the adjacent inductors 41 and 42 run parallel or at right angles to one another. As a result, it is also the case that those regions of the windings 43 to 46 which are located between the adjacent inductors 41 and 42 of one of the induction units 10 can be utilized for warming or heating the food.

In order that such an arrangement of inductors 41 and 42 can function despite the outer turn sections 51 to 54 of the adjacent inductors 41 and 42 being located so close up against one another, it is necessary for the windings 43 to 46 to observe a certain winding direction. The first supply lead 47 is connected to that turn of the winding 45 of the second inductor 42 of the bottom induction unit C which is located on the outer periphery. The second supply lead 48 is connected to the central turn of the winding 46 of the first inductor 41 of the bottom induction unit C. In this case, the helix of the winding 45 of the second inductor 42 of the bottom induction unit C opens in the counterclockwise direction. In contrast, the helix of the winding 46 of the first inductor 41 of the bottom induction unit C opens in the clockwise direction.

The central turn of the winding 45 of the second inductor 42 of the bottom induction unit C is connected, with the aid of a first connecting lead, to the outer turn of the winding 44 of the second inductor 42 of the top induction unit B. The central turn of this winding 44 is connected, with the aid of a further connecting lead, to the outer turn of the winding 43 of the first inductor 41 of the top induction unit B. The central turn of the latter winding 43 is connected, with the aid of yet a further connecting lead, to the outer turn of the winding 46 of the first inductor 41 of the bottom induction unit C. The helix of the winding 44 of the second inductor 42 of the top induction unit B opens in the clockwise direction, while the helix of the winding 43 of the first inductor 41 of the top induction unit B opens in the counterclockwise direction.

As a result of such an interconnection of the windings 43 to 46, the current in the outer, rectilinear and parallel sections 51 to 54 of the adjacent windings 43 to 46 flow in the same direction at any one point in time. In such a case, the outer and parallel conductors 51 and 54 of the adjacent inductors do not adversely affect one another, and these conductors and/or the inductors 41 and 42 may thus be arranged as closely together as this.

FIG. 4 shows, in a vertical section, and on an enlarged scale, a detail of a second embodiment of the present apparatus. This apparatus comprises an oven 58 with a frame 59. Practically horizontally running and hollow bases 60 located one above the other project away like trays from the inner surface 69 of the side wall 57 of the frame 59. The respective base 60 thus has one of its peripheral parts fixed to, or integral with, the inside 69 of the side wall 57 of the oven 58. The distance between two bases 60 located one above the other corresponds to the height of a food container 20. The basic body 61 of the respective base 60 comprises two horizontal panels 62 and 63 which are located one above the other, run practically parallel to one another and between which an induction unit 10 is located. The distance between the panels 62 and 63 of a base 60 corresponds to the height of an induction unit 10. The panels 62 and 63 and/or the base 60 may extend practically over the entire depth (FIG. 2) of the oven 58 or 1. It is expedient if the length of the panels 62 and 63 corresponds to the sum of two longer sides of the rectangular induction units 10, which butt against one another by way of their shorter sides.

The longer edges of the panels 62 and 63, these edges being located in the interior of the oven 58, are connected to one another with the aid of an end wall 64, which is located practically at right angles to these panels 62 and 63. This end part 65 terminates the base 60 in a practically air-tight manner in the interior of the oven 58. The end wall 64 and the panels 62 and 63 define a cavity 66 in the interior of the respective base 60. This cavity 66 opens out into a practically horizontally running slot-like opening 67 which is made in the outer surface 68 of the side wall 57 of the oven 58. Two induction units 10 are arranged one behind the other, in the manner described in conjunction with FIGS. 1 and 2, in the cavity 66 of the base 60, these induction units having been pushed into the interior 66 of the base 60 through the outer opening 67 in the side wall 57.

This configuration of the oven 58 gives rise to significant advantages. The frame 2 of the oven 58 may be produced from a plastic, the mold for producing the frame 2 being designed such that all the bases 60 of a wall 3 or 4 can be produced in a single operation. A further important advantage is that the supply lines which connect the induction units 10 to one another, etc. can be guided easily, and without obstruction, through the openings 67, which open out in the outward direction. This configuration of the frame 2 of the oven 58 does indeed allow the already described food trolley 30 to be used, but it is also possible for the containers 20 to be placed directly on the bases 60, without the trolley 30 having to be used.

FIG. 5 shows, in perspective, a further possible embodiment of the present oven 80. The frame 81 of this oven 80 has a panel-like base 82 which is essentially quadrilateral; in the case illustrated, it is rectangular. Extending upward from one of the sides of the base panel 82 is a rear wall 83, the width of which corresponds to the length of this side of the base panel 82. Extending upward from another side, or one of the longer sides, of the base panel 82 is a side wall 84, the width of which corresponds to the length of this side of the base panel 82. These walls 83 and 84 of the frame 81 are fixed not just to the base panel 82, but also to one another via their common vertically running edges 86, so that the frame 81 of this oven 80 constitutes a rigid structure. The stability of the frame 81 is increased by a top wall 79, of which in each case one side of the same is fixed to the top horizontal edge of the rear wall 83 and the side wall 84. In the case of such an oven, the front side and one of the sides are thus open. There may be doors (not illustrated) with the aid of which these open sides of the frame 59 can be closed in a manner which is known per se. The underside of the base panel 82 of this oven 80 may be provided with rollers 78, so that the oven 80 is mobile, which allows for further possible applications of this oven 80.

Elongate holders 88 having slits 87 are fastened on the inside 85 of the frame side wall 84. These elongate holders 88 run practically horizontally, and the distance between two holders 88 located one above the other corresponds approximately to the height of a food container 20 which is to be placed therebetween. The elongate holders 88 advantageously extend over the entire length or width of the side wall 84. The cross section of one of the holders 88 is essentially in the form of the letter A. That surface which extends between the ends of the legs of the letter A constitutes the base surface of this holder 88, and the holder 88 is fastened on the side wall 84 via this base surface. The slit 87 extends from the tip of the letter A toward the abovementioned base surface of the holder 88, and the width thereof is selected such that an induction unit 10 fits firmly into this slit 87.

In order to improve this fit further, there are also such holders 89 on the inside of the rear wall 83, which is located at right angles to the side wall 84. Each of these second holders 89 is located in the same plane as one of the first holders 88 on the side wall 84. Consequently, two peripheral regions of the respective induction unit 10 which are located at right angles to one another are held in place by two holders 88 and 89. The containers 20 may be placed directly on the panel-like induction units 10, or they can be moved between two induction units 10 with the aid of the abovedescribed trolley. The base of the slits 87 in the holders 88 and 89 may contain openings which, at the other end, open out into the abovementioned base surface of the holder 88 or 89. The supply lines of the inductors 10 can pass through these openings and thus reach the outside of the side wall 84.

FIG. 6 shows a further possible way of configuring the walls of the oven 90. The walls of the oven 90 comprise profile components, of which the approximately cuboidal frame 91 is made up. The already mentioned holders 88 for accommodating the induction units 10 are fastened on the inside of the walls of such a frame. Criss-crossing struts 92 and 93 are provided in order to increase the rigidity of such a frame 91, the ends of these struts being fastened on the horizontal edges of the frame sides. In the region of the crossover location, the struts 92 and 93 are fixed to one another, for example with the aid of a vertically running rail. It is also possible for this frame to be provided with the rollers 78 which have already been mentioned.

FIG. 7 shows a front view of the bottom section of a second embodiment of the present apparatus. The design of the oven 1 in the case of this further embodiment of the present apparatus is essentially identical to that which is shown in FIG. 1. For regeneration, the food containers 20, in the present case, are placed in a handling framework 70. This handling framework 70 has a base panel 71 which runs practically horizontally and on the underside of which sliding means, for example runners 72 and 73, are fitted. The dimensions of the base panel 71 together with the runners 72 and 73 are selected such that the base panel 71 together with the runners 72 and 73 may be placed in the free space 9 extending between the floor 5 of the oven frame 2 and the lowermost induction units 10.

A flat basic body 75 of the food trolley 30 extends upward approximately from the center of the base panel 71. In the example illustrated, this basic body 75 comprises two vertically running and spaced-apart panels 751 and 752 which extend over the entire height and over practically the entire length or depth of the oven 1. Practically horizontally running, flat bases 76 jut out from the outside of these basic-body panels 751 and 752 and can have the food containers 20 placed on them. The height position of the respective base 76 above the base panel 71 is selected, in respect of the induction units 10, such that the underside of the respective base 76 is as close as possible to the top side of the induction unit 10 arranged therebeneath. This is the case in order that the bottom part 21 of the food container 20 is as close as possible to the induction unit 10 arranged therebeneath.

On the one hand, the runners 72 and 73 allow the handling framework 70 to be pushed into the oven 1 and pulled out of the oven 1 again. On the other hand, the runners 72 and 73 allow the handling framework 70, together with the regenerated food, to be placed, practically without sliding, on a serving trolley (not illustrated). This handling framework 70 loaded with the regenerated food can be wheeled to the passengers or guests and the food can be distributed directly to the latter from the handling framework 70 without the food containers 20 having to be transferred between regeneration of the food in the oven 1 and distribution to the passengers or guests.

FIG. 8 shows a side view of a further embodiment of the present apparatus, it being possible for this embodiment to serve as a tunnel oven. FIG. 9 shows a horizontal section A-A through the apparatus according to FIG. 8. In the case illustrated, three individual ovens 58 are connected one behind the other in a sealed manner such that the trolleys 30 or the handling frameworks 70 can be displaced from one individual oven 58 to the other. An arrow R indicates the direction of movement of the food containers 20 in the tunnel oven. In the case illustrated, it is possible for three accommodating arrangements 30 or 70 for the food containers 20 to be located one behind the other in the tunnel oven and to be moved advantageously intermittently in the direction indicated. FIG. 9 shows the position of the induction units 10 in the tunnel oven.

That configuration of the oven 58 which is shown in FIG. 4 is best suited for such an embodiment of the present apparatus. As has already been explained, the panels 62 and 63 of the respective base 60 define, together with the end wall 64 located in the interior of the oven 58, a cavity 66 which opens out into the outer surface 68 of the side wall 3 or 4 of the oven 58 by way of an opening 67. Supply lines which connect the induction units 10 to one another etc. may be guided through these openings 67. It is thus only possible for the supply lines to be guided on the outer surface 68 of the sides 3 and 4 and on the outside of the top of the oven 58, so that the end surfaces of the tunnel are free for the introduction of the trolleys 30 and/or of the handling frameworks 70 into the tunnel oven. A trolley 30 or a handling framework 70 can accommodate, for example, 36 food containers 20. The tunnel oven according to FIGS. 8 and 9 can accommodate 108 food containers 20, which is particularly advantageous, in particular, for catering for a large number of people. In the case of mass catering, however, it is also possible for the individual ovens 1 and 58 to be arranged one beside the other and/or one above the other.

FIG. 10 shows a further possible embodiment of the present apparatus, this time with an oven 100. The frame on the housing 101 of this oven 100 is essentially in the form of the housing 2 of the oven 1 according to FIG. 1. In specific terms, however, the frame 101 may be configured rather more as has been described in conjunction with FIG. 4. In the case illustrated, the respective base 102 of this frame 101 is made of solid material and is integral with the relevant side wall of the frame 101. A depression 103 (FIG. 11) is made in the top side of the respective base 102 from above. The dimensions of this depression 103 are selected such that at least one of the induction units 10 can be incorporated in this depression 103 such that the surface of this induction unit 10 is flush with the surface 104 of the base 102. In the case illustrated, the top side of the induction unit 10 is provided with a laterally projecting, advantageously all-round collar 105 which is located in a groove 106 in the top periphery of the depression 103. The supply lines 47 and 48 for the respective induction unit 10 are guided through the side wall 107 of the frame 101. The containers 20 with the food may be located on the inductor 10 incorporated in the base 102, or they can be retained at a distance above the base 102 with the aid of the trolley 30 or holder 35.

Conventional cookers each have a switch for each induction unit, with the aid of which the respective induction unit can be switched on and off. The abovedescribed ovens have a large number of induction units 10, so that they would also have to have a corresponding number of switches. From a technical point of view, there would be no difficulty in assigning each induction unit a dedicated switch. From the point of view of operating the oven, however, this solution would be unsatisfactory because, when food containers 20 are pushed into the oven with the aid of the trolley 30 or of the holder 35, it would be necessary to actuate a number of switches corresponding to the number of food containers.

This problem can be eliminated, for example, by a circuit arrangement which is illustrated in FIG. 12. This circuit arrangement has a powerful generator 110 of alternating current with a frequency which is customary for operating induction units 10. This frequency is between approximately 22 and 30 kHz. LC branches 111 are connected in parallel with one another between the output terminals of this generator 110. Each of these branches 111 comprises a condenser 112 and at least one coil 113 connected in series therewith. The respective coil 113 is illustrated by one of the windings 43 to 46 (FIG. 2). In the case which is illustrated in FIG. 12, in each case six coils 113 are connected in series with the respective condenser 112. In the case of six branches 111 illustrated in FIG. 12, a single generator 110 can supply energy to thirty-six coils 113 connected to the generator in this way.

The resonant frequency of the branches 111 is expediently below 20 kHz. The frequency of the supply current from the generator 110, as has already been mentioned, is between 22 and 30 kHz, i.e. above the resonant frequency of the branches 111. If a food container 20 is assigned to one of the coils 113 in one of the branches 111, then the phase angle between the supply voltage and the supply current in this coil 113 has a minimum value, so that energy is emitted to this food container 20. If there is no food container 20 assigned to one of the coils 113 in one of the branches 111, then the phase angle between the supply voltage and the supply current has a value of virtually 90 degrees. In the case of this phase displacement, a minimum current flows through the coil 113 and there is no energy emitted by way of this coil 113. Of course, the respective branch 111 may also have some other number of coils 113, it also being possible for the branch 111 to have just a single coil 113.

FIG. 13 shows a second circuit arrangement which can eliminate the problem mentioned above. This circuit arrangement comprises a clock generator 115 to which heating circuits 116 are connected. The respective heating circuit 116 comprises a powerful output stage 117 with a resonant circuit 118 connected to its output. This resonant circuit 118 contains a condenser 112 and a coil 113. This coil 113 may be one of the windings 43 to 46 of the oven, as has been shown above. Since all the coils 113 of the oven run synchronously, on account of the clock generator 115, the adjacent coils 113, located close up against one another, in the bases of the oven cannot adversely affect one another. The respective resonant circuit 118 functions in an essentially identical manner to the resonant circuits 111 described above. The circuit arrangement according to FIG. 13 has a certain disadvantage in relation to the circuit arrangement according to FIG. 12, namely by the fact that the circuit arrangement according to FIG. 13 requires a number of power stages 117 equal to the number of resonant circuits 118.

FIG. 14 shows a plan view of a further embodiment of the present apparatus, this embodiment being configured as a so-called hot plate 95. Hot plates 95 usually have a horizontally running surface 96 on which are placed the food, in its abovedescribed containers 20, which is to be distributed. Such hot plates 95 are mostly in the form of a table. The containers 20 are placed on the table 96 and are accessible from above. It is thus possible to remove the individual foodstuffs from the relevant containers 20 on the hot plate 95. However, since it is also necessary, in some circumstances, for the food to stand on the table 96 for comparatively long periods of time, the temperature of the food has to be kept at a certain level over a relatively long period of time. For this purpose, induction units 10 are assigned to the horizontal surface 96. These induction units 10 are expediently set into the horizontal surface 96, so that it is also possible for the containers 20 just to be placed partially on the relevant induction unit 10. In the case which is illustrated in FIG. 14, the induction units 10 form two rows. Of course, it is also possible to have a different number of rows of induction units 10. The number of induction units 10 in a row may also be selected in terms of expediency. A row may contain, for example, eighteen induction units 10, so that such a hot plate 95 then comprises thirty-six induction units 10. The inductors of the induction units 10 are connected to one another and then jointly to at least one generator 110, as has been explained above in conjunction with FIGS. 12 and 13.

The present apparatus can be used, in particular, for regenerating food onboard airplanes and on trains and coaches and for mass catering.

1. An apparatus for treating food, characterized in that it has planar induction units (10) which are arranged at least one beside the other and between which containers (20) having the food which is to be treated may be placed.

2. The apparatus as claimed in patent claim 1, characterized in that it comprises an oven (1, 58) which has at least one side wall (3, 4), in that the induction units (10) have one of their peripheral parts (29) assigned to this side wall (3, 4), so that the induction units (10) form open compartments (19) which are present between two induction units (10) located one above the other, in that the main plane of the induction units (10) runs practically horizontally, and in that the distance between two induction units (10) located one above the other corresponds to the height of a food container (20).

3. The apparatus as claimed in patent claim 2, characterized in that the respective container comprises a hollow or bowl-like bottom part (21) and a lid (22), and in that the bottom part (21) and the lid (22) of the container (20) are made of a material in which it is possible to induce eddy currents.

4. The apparatus as claimed in patent claim 2, characterized in that the basic body of the oven (1, 58) is configured as a frame (2), and in that the planar induction units (10) are assigned to the inside (59) of the side walls (3, 4) of this frame (2).

5. The apparatus as claimed in patent claim 4, characterized in that the frame (2) is of such a width as to provide a free space between the mutually facing inner peripheral parts (18, 65) of the compartment bases, these being assigned to the mutually opposite side walls (3, 4) of the oven frame (2).

6. The apparatus as claimed in patent claim 1, characterized in that it comprises an arrangement (30, 70) for accommodating the food containers (20) which has a practically vertically running basic body (31), and in that holders (35) or bases (76) for accommodating the food containers (20) project from at least one of the sides of this basic body (31).

7. The apparatus as claimed in patent claim 5, characterized in that the vertically running basic body (31) of the trolley (30) is only wide enough for it to be placed in the free space between the mutually facing inner peripheral parts (18, 65) of the compartment bases (10, 60).

8. The apparatus as claimed in patent claim 3, characterized in that the frame (2) of the oven (58) has practically horizontally running bases (60) located one above the other, in that the respective base (60) has one of its peripheral parts adjoining the inside (59) of one of the side walls (3, 4) of the oven (58), in that the base (60) is hollow, and in that the dimensions of the cavity (66) in the base (60) are such that at least one of the induction units (10) may be placed in the cavity (66) of the base (60).

9. The apparatus as claimed in patent claim 8, characterized in that an elongate opening (67) is present in place of the side wall (3, 4) of the oven (58), and one of the hollow bases (60) is located there, and in that the cavity (66) in this base (60) adjoins the wall opening (67) such that at least one of the induction units (10) can be introduced through the wall opening (67) into the cavity (66) in the base (60).

10. The apparatus as claimed in patent claim 1, characterized in that an induction unit (10) has at least two inductors (41, 42) located in the same plane or one beside the other.

11. The apparatus as claimed in patent claim 10, characterized in that induction units (10) located one above the other form induction groups, in that the coils of the inductors in these induction units (10) are connected in series, and in that the windings of the adjacent coils are oriented in opposite directions.

12. The apparatus as claimed in patent claim 3, characterized in that the inside (59) of the side wall (3, 4) is provided with practically horizontally running clamps (13) arranged one above the other, and in that the peripheral part (29) of the respective induction unit (10), this peripheral part being assigned to the side wall, is kept in place by these clamps (13).

13. The apparatus as claimed in patent claim 6, characterized in that the height position of the bases (76) in relation to the induction units (10) is selected such that the underside of the respective base (76) is as close as possible to the top side of the induction unit (10) arranged therebeneath.

14. The apparatus as claimed in patent claim 2, characterized in that a number of ovens (1, 58) are arranged one behind the other such that the food containers (20) can be conveyed from one oven to the other oven.

15. The apparatus as claimed in patent claim 1, characterized in that heating circuits which have induction units (10) are provided, in that the respective heating circuit comprises at least the winding (43, 44, 45, 46) of one of the induction units (10) which is connected in series with a condenser (112), so that these elements interconnected in this way form a branch (111), in that such LC branches (111) are connected in parallel with one another, and in that such a circuit arrangement is connected to a generator (11).

16. The apparatus as claimed in patent claim 1, characterized in that heating circuits which have induction units (10) are provided, in that the respective heating circuit comprises the winding (43, 44, 45, 46) of one of the induction units (10) which is connected in series with a condenser (112), so that these elements interconnected in this way form a branch (111), in that such an LC branch (111) is connected to a generator (117), and in that the generators (117) are connected to a clock generator (115).

17. The apparatus as claimed in patent claim 6, characterized in that the vertically running basic body (31) of the trolley (30) is only wide enough for it to be placed in the free space between the mutually facing inner peripheral parts (18, 65) of the compartment bases (10, 60).
